(19) United States
(12) Patent Application Publication
(10) Pub. No.: US 2004/0010476 A1
(43) Pub. Date: Jan. 15, 2004

(54) Systems, methods and devices for scanning parcels for hazardous materials

(76) Inventors: Robert Rumph, Sumter, SC (US); John Bourgeois, Charlotte, NC (US); Scott Rumph, Sumter, SC (US)

Correspondence Address: Finnegan, Henderson, Farabow,, Garrett & Dunner, L.L.P., 1300 I Street, N.W., Washington, DC, 20005-3315, US

(21) Appl. No.: 10/272,305

(22) Filed: Oct. 17, 2002

Related U.S. Application Data
(60) Provisional application No. 60/329,532, filed on Oct. 17, 2001.

(51) Int. Cl. G06F 17/60

(52) U.S. Cl. 705/406

(57) ABSTRACT

This invention may involve a mobile parcel checking method, including training at least one individual on how to check parcels for hazardous contents and then offering parcel scanning services to at least one organization. A parcel scanner may be are dispatched to a site of the organization where the scanner checks parcels for at least one of chemical hazards, biohazards, and explosive hazards.

### PRIORITY CLAIM

This application claims priority based on Provisional Patent Application No. 60/329,532, filed Oct. 17, 2001.

### DESCRIPTION OF THE INVENTION

### BACKGROUND OF THE INVENTION

The mail rooms of many organizations are ill-equipped to detect biohazards, chemical hazards, explosives, or other dangerous materials that might be received by hand-delivery, through an express courier service, through a national mail carrier system, or through other couriers (collectively “parcel couriers”).

### SUMMARY OF A FEW ASPECTS OF THE INVENTION

In accordance with the invention, one aspect of this invention involves a method for detecting hazardous materials in inbound parcels for large companies, businesses, government entities and other institutions (hereinafter collectively referred to as “organizations”).

Another aspect of the invention involves a process of offering a service to organizations where outside parcel screeners might enter a parcel receiving facility of the organization on a periodic basis, donning appropriate safety gear, to safely pre-scan parcels for one or more of chemical hazards, bio-hazards, or explosive hazards.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flow diagram of an on-site scheme consistent with one aspect of the invention.

FIG. 2 is a flow diagram of an diverted scheme, consistent with the invention.

FIG. 3 is a flow diagram for implementing one aspect of the invention.

### DESCRIPTION OF THE EMBODIMENTS

Reference will now be made in detail to the present embodiments (exemplary embodiments) of the invention, examples of which are illustrated in the accompanying drawings.

As used herein, the term parcels includes all mail, packages, or other goods delivered by any parcel courier such as a national or regional mail carrier (e.g., the United States Postal Service), a private national, international or regional courier (e.g. Federal Express and United Parcel Service), a local courier company, or any other form of delivery.

The parcel screeners might be trained to detect and properly handle parcels suspected of containing bio-hazardous, chemical hazardous or explosive substances such as viruses, toxic chemicals or mail bombs. This training may included a formal program, perhaps culminating in a certification. For already experienced employees, the training may, at the very least, include advising parcel screeners about company policies and procedures for handling parcels.

The parcel screeners might don Level A or Level B attire. For example, they might wear masks (e.g. gas masks) and/or full body positive pressure suits that permit positive pressure breathing of air.

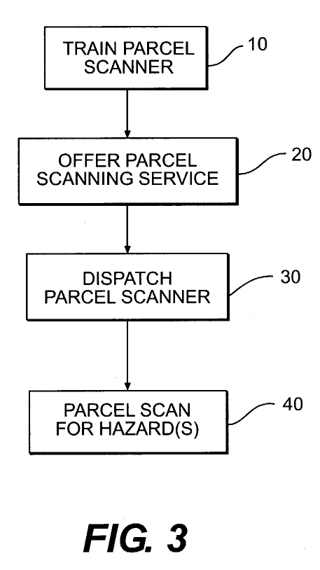

The invention may also involve providing a service of safely containing and/or disposing of suspected hazardous material. (See 20 in FIG. 3). However, in its broadest sense, the service might simply identify potential hazards, and notify appropriate authorities. The invention may also involve implementing precautionary measures when a potential hazard is detected. The precautionary measures may include overseeing immediate evacuations of the organization's personnel and stop-gap quarantines until authorities arrive.

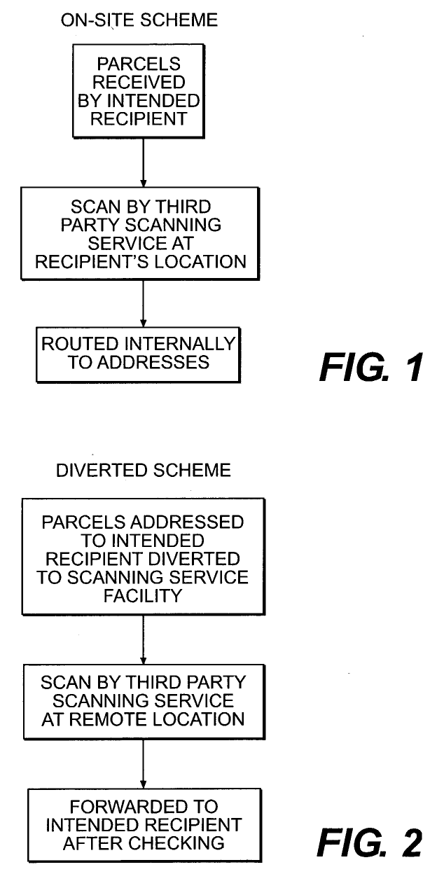

A method consistent with one aspect of the invention may involve providing such a service on a contract basis where parcel screeners visit the organization on a daily or other regular basis. (See e.g., FIG. 1, on-site scheme). The parcel screeners might be authorized to check all parcels, or only parcels that appear suspicious. Billing for such services may be for example on an hourly basis, based on volume, or based on projected volume.

A method consistent with another aspect of the invention may involve setting up franchises to provide parcel scanning services, with franchises being organized by geographical location. For example, in large cities, a franchise may involve a single office building or a group of office buildings. In smaller cities, a franchise may involve an entire city or a business district within a city.

Parcel scanners might follow a predetermined route (dispatch 30, FIG. 3), arriving at customers' facilities at roughly the same time every day. The scheduled arrival time might generally coincide with the regular time of parcel delivery so as to minimize delay of distribution of mail within the customer's business. Parcel scanning services offered in the morning hours may be of a higher value to organizations than afternoon services, and therefore the rates charged for services may be a function of the time of day the services are provided.

In another aspect, the invention may involve assisting customers in establishing parcel receipt procedures. The invention may involve establishing a secure room, perhaps with a special ventilation system, in which parcels are stored and checked before distribution to addressees. Such a “safe room” may be located within the business itself, may be shared among a few businesses, or may be maintained in an office building for use by multiple businesses within the same office building or within a common geographical area. Personnel who provided scanning services might be equipped with a vehicle/van carrying all necessary items to safely perform inspection, as well as proper containers to seal or encapsulate any suspicious items that might require off-site analytical work.

In another aspect, the invention may involve establishing a set of uniform (perhaps national) guidelines regarding how the mail and parcel scanning process should be performed and what is required to do it safely.

As used herein, the terms “scanning” and “screening” are used interchangeably to broadly to include one or more of checking parcels for possible hazards, subjecting parcels to a process for neutralizing possible hazards, and isolating parcels suspected of containing possible hazards. Processes for neutralizing possible hazards may include one or more procedures that subject mailpieces to chemical(s), heat, radiation, gas, light, or other processes for sanitizing a biological or chemical hazards. (40 in FIG. 3). Such devices might be portable and might be transported from customer to customer by the parcel screeners. They might be left in the parcel screener's vehicle until needed or might routinely be carried to the job site either manually, on a cart, or in a powered vehicle. Alternatively, such sanitizing devices could be installed on-site at the customer's organization or even at central parcel distribution facilities such as U.S. Post Office distribution centers. Such sanitizing devices might also be used by Federal Express, UPS, or other mailpiece couriers. This could be a process that could be used by the U.S. government as well.

Consistent with the invention, processes for performing mail scanning may be manually based or machined based. For example, parcel screeners might be trained to visually inspect parcels for hazards, they might open only those parcels deemed to be suspicious, or they may open and inspect the contents of all parcels received by a customer organization. Alternatively or in conjunction therewith, machines that can detect content without requiring opening of the parcel (such as x-ray type devices) may be used to check parcel content before opening. These machines, like the neutralizing machines previously discussed, may be portable or may be installed at a customer facility or separate facility (including but not limited to a facility of a parcel courier).

In one respect, the invention may involve providing customer organizations with checking and/or neutralizing machines on a contract or lease basis.

In an alternative embodiment (see e.g., FIG. 2), an organization might have some or all of its parcels routed through a special hazard checking facility. In such an instance, the organization might direct a postal service or other courier to route incoming parcels through the independent hazard checking facility. After checking, and/or neutralizing, the parcels might be hand-delivered by authorized personnel to the organization. For added security, once parcels have been checked and/or neutralized, they might be bundled in a sealed sack, container, or other package. In such an instance, the special hazard scanning facility might alternatively deposit the secure package with a courier (e.g., UPS or USPS) for routing to the customer. While this special hazard checking facility might be particularly beneficial for use by organizations, it can also be used to scan parcels addressed to residential customers.

As an alternative to securely packaging prescanned parcels, the parcels might be marked as checked or sanitized for customer confirmation purposes. Such markings may include ink, labels, or, unique bands around a single parcel or a group of parcels.

Consistent with another aspect of the invention, the scanning facility may be configured to offer the service of opening parcels and digitally recording (or recording in some other manner) the parcel's contents. The recorded contents may then be electronically transmitted to the customer or employee of the customer over a network (e.g., the internet, private network, virtual private network, or some other remote transmission means). This process may be performed manually, or machines might be configured to perform one or more of the functions of opening the parcels such as mailing envelopes, scanning them, using a program such as optical character recognition (OCR) to identify the intended recipients, electronically routing the mail to the intended recipients, and storing the hard copy in a manner in which it may be readily located and retrieved upon request from the customer. At the time of remote receipt or for a predetermined period of time thereafter, the recipient may be permitted to select an option of receiving the original hard-copy of the mailpiece. If no such request is made, the original may be destroyed. Such a request might be made, for example, using a mouse to click on a button on a display device. Multiple buttons may be provided, such as “Send Hard Copy,” “Destroy Original,” or “Hold.” An additional service fee might be charged for holding hard copy beyond a predetermined time frame.

Another aspect of the invention involves the development of a scannable transparent type of paper for envelopes, boxes, tape, glue, etc., for facilitating contents scanning. For example, paper products may be porous. One or more of the materials would have to be designed to enable the passage of air, light, radiation, or heat, depending on the scanning mechanisms employed. A detectable marking on, or security device embedded in the material might be read by a machine to confirm that the parcel is scannable. Otherwise, the parcel might be ejected from a processing line for alternative inspection.

Another aspect of the invention may involve providing equipment and proper training within an organization so that the organization may use its own personnel (or contract personnel) to provide parcel scanning services. Further, outside personnel may be available on an emergency basis when a suspicious package or other parcel is identified. Such a service may be billed on a subscription basis, with or without a surcharge for each on-site visit.

Another aspect of the invention may involve providing the scanning service to residential customers. Residential customers may provide authority to the scanning entity to access household mailboxes, scan mail at the location of the mailbox, and thereafter package the mail in a sealed envelope certifying that the mail has been scanned. As an alternative to packaging, each checked mailpiece may be marked, or a note affixed to the mailpiece or placed in or on the mailbox, confirming pre-scanning. Consistent with this aspect, a private vehicle may follow a route, stopping at customers' mailboxes and prescreening the mail before the customer accesses the mailbox. The vehicle may contain one or more of the scanning devices previously discussed.

Alternatively, and as discussed previously, household mail, like business mail, may be directed through a scanning facility and thereafter delivered to the household.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A mobile parcel checking method, comprising:
training at least one individual on how to check parcels for hazardous contents;
offering parcel scanning services to at least one organization;
dispatching the at least one individual to a site of the at least one organization; and
directing the at least one individual to scan the parcel of the entity for at least one of chemical hazards, biohazards, and explosive hazards.

2. A method of claim 1, wherein the at least one individual is dispatched to sites of multiple organizations in a single day.

3. A method of claim 2, wherein the at least one individual is assigned a periodic route for visiting the multiple organizations.

4. The method of claim 3, wherein the periodic route is a daily route.

5. The method of claim 1, wherein during screening, the individual dons safety attire.

6. The method of claim 5, wherein the safety attire includes a mask equipped with a filter.

7. The method of claim 5, wherein the safety attire includes a sealed suit.

8. The method of claim 1, wherein when the at least one individual visits each entity the at least one individual is instructed to carry a container for encapsulating a suspicious item.

9. The method of claim 1, wherein the parcel screening services are offered on an emergency basis, and wherein the dispatching occurs when an organization identifies a suspicious parcel.

10. A method for scanning parcels for hazardous materials, the method comprising:
offering a scanning service to an organization;
receiving at a scanning facility, parcels addressed to the organization;
scanning the parcels at the scanning facility in an attempt to identify hazardous material contained in one or more of the parcels; and
delivering the parcels to the organization after scanning.

11. The method of claim 10, further comprising directing the organization to contact one or more parcel carriers that typically delivers parcels to the organization, and asking the one or more parcel carriers to redirect the organization's parcels to the scanning facility.

12. The method of claim 10, wherein scanning includes checking for hazardous materials and neutralizing the hazardous materials with at least one decontamination procedure.
